(19) United States
(12) Patent Application Publication
(10) Pub. No.: US 2017/0096598 A1
(43) Pub. Date: Apr. 6, 2017

(54) Self-Suspending Functionalized Proppant Particulates For Use In Subterranean Formation Operations

(71) Applicant: Halliburton Energy Services, Inc., Houston, TX (US)

(72) Inventors: Loan K. Vo, Houston, TX (US); Corneliu Stanciu, Kingwood, TX (US); Philip D. Nguyen, Houston, TX (US)

(73) Assignee: Halliburton Energy Services, Inc., Houston, TX (US)

(21) Appl. No.: 15/312,018

(22) PCT Filed: Aug. 15, 2014
(86) PCT No.: PCT/US2014/051357

§ 371 Date: Nov. 17, 2016

(51) Int. Cl. C09K 8/88; C09K 8/575; C09K 8/80; C09K 8/68

(52) U.S. Cl. CPC C09K 8/887; C09K 8/685; C09K 8/5756; C09K 8/805

(57) ABSTRACT

Functionalized proppant particulates including proppant particulates having functional groups chemically deposited thereon, the functional groups selected from the group consisting of an epoxy silane group, an amine silane group, an acrylyl silane group, and any combination thereof, and a swellable material chemically bound to one or more of the functional groups.

### BACKGROUND

The embodiments herein relate generally to subterranean formation operations and, more particularly, to self-suspending functionalized proppant particulates.

Subterranean wells (e.g., hydrocarbon producing wells, water producing wells, and the like) are often stimulated by hydraulic fracturing treatments. In hydraulic fracturing treatments, a gelled treatment fluid is often pumped into a portion of a subterranean formation at a rate and pressure such that the subterranean formation breaks down and one or more fractures are formed therein. Particulate solids, such as graded sand, are typically suspended in at least a portion of the treatment fluid and deposited into the fractures in the subterranean formation. These particulate solids, or “proppants particulates” (also referred to simply as “proppants”) serve to prop the fracture open (e.g., keep the fracture from fully closing) after the hydraulic pressure is removed. By keeping the fracture from fully closing, the proppant particulates aid in forming conductive paths through which produced fluids, such as hydrocarbons, may flow.

Hydraulic fracturing treatments may also be combined with sand control treatments, such as a gravel packing treatment. Such treatments may be referred to as “frac-packing” treatments. In a typical frac-packing treatment, a gelled treatment fluid comprising a plurality of proppant particulates is pumped through the annulus between a wellbore tubular mounted with a screen and a wellbore in a subterranean formation. The fluid is pumped into perforations through a casing, or directly into the wellbore in the case of open hole completions at a rate and pressure sufficient to create or enhance at least one fracture, and the proppant particulates are deposited in the fracture and in the annulus between the screen and the wellbore. The proppant particulates aid in propping open the fracture, as well as controlling the migration of formation fines or other loose particles in the formation from being produced with produced fluids.

The degree of success of a fracturing operation (both a traditional hydraulic fracturing operation and a frac-packing operation) depends, at least in part, upon fracture porosity and conductivity once the fracturing operation is complete and production is begun. Fracturing operations may place a volume of particulates into a fracture to form a “proppant pack” or “gravel pack” (referred to herein as “proppant pack”) in order to ensure that the fracture does not close completely upon removing the hydraulic pressure. In some fracturing operations, a large volume of proppant particulates may be placed within the fracture to form a tight proppant pack. In other fracturing operations, a much reduced volume of proppant particulates may be placed in the fracture to create larger interstitial spaces between the individual particulates. However, both fracturing approaches may result in at least some settling of the proppant particulates within a treatment fluid as the treatment fluid is introduced downhole or after placement in a fracture opening.

Proppant particulate settling may lead to a fracture or a top portion of a fracture closing, which may lower the conductivity of the proppant fracture and result in proppant masses having little or no interstitial spaces at the bottom portion of a fracture, thereby further decreasing the conductivity of the fracture. Proppant settling may be particularly problematic in cases where larger or heavier proppant is used in place of traditional proppant particulates which may be more difficult to hold in suspension. While settling may be counteracted by using a high pump rate or by increasing the viscosity of the fluid carrying the proppant particulates, such methods often lose effectiveness once the fluid comprising the proppant is placed into a fracture and before the hydraulic pressure is released.

### BRIEF DESCRIPTION OF THE DRAWINGS

The following FIGURES are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 depicts an embodiment of a system configured for delivering the treatment fluids comprising the functionalized proppant particulates of the embodiments described herein to a downhole location.

### DETAILED DESCRIPTION

The embodiments herein relate generally to subterranean formation operations and, more particularly, to self-suspending functionalized proppant particulates. The functionalized proppant particulates of the embodiments described herein utilize swellable material to self-suspend in a treatment fluid for use in a subterranean formation operation.

In some embodiments, the methods and compositions described herein may be with reference to a hydraulic fracturing operation (e.g., formation of a proppant pack). However, the functionalized proppant particulates may be used in any other subterranean formation operation that may employ a treatment fluid comprising a gelling agent and that may benefit from having a suspended particulate. Such subterranean formation operations may include, but are not limited to, a stimulation operation; an acidizing operation; an acid-fracturing operation; a sand control operation; a fracturing operation; a frac-packing operation; a remedial operation; a near-wellbore consolidation operation; and any combination thereof.

One or more illustrative embodiments disclosed herein are presented below. Not all features of an actual implementation are described or shown in this application for the sake of clarity. It is understood that in the development of an actual embodiment incorporating the embodiments disclosed herein, numerous implementation-specific decisions must be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill the art having benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps. When “comprising” is used in a claim, it is open-ended.

In some embodiments, the present disclosure provides functionalized proppant particulates comprising proppant particulates having functional groups chemically deposited thereon. Such chemical deposition of the functional groups onto the proppant particulates may occur, for example, by reacting a silane functional group with the hydroxyl groups on the proppant particulates. For example, in one embodiment, a Si(OMe)₃ functional group may react with hydroxyl groups on the surface of the proppant particulates, thereby displacing and eliminating methanol and forming the covalent siloxane bond Si—O—Si. A swellable material is chemically bound to one or more of the functional groups, and may be bound thereto prior to chemically depositing the functional group onto the proppant particulate or thereafter. The bond between the functional group and the swellable material may be a covalent bond. The swellable material has an unswelled volume and a swelled volume, and may swell in the presence of an aqueous fluid. In some embodiments, the swellable material may be bound in its unswelled volume or swelled volume. For dry storage, for example, the swellable material may preferably be in its unswelled volume such that the space required for storage is reduced.

In some embodiments, the swelled volume of the swellable material may be between a lower limit of about 30 times, 31 times, 32 times, 33 times, 34 times, 35 times, 36 times, 37 times, 38 times, 39 times, and 40 times to an upper limit of about 50 times, 49 times, 48 times, 47 times, 46 times, 45 times, 44 times, 43 times, 42 times, 41 times, and 40 times greater than the unswelled volume of the swellable material, encompassing any value and subset therebetween. In other embodiments, the mass of the swellable material in its swelled volume may be between a lower limit of about 30 weight percent (“wt %”), 90 wt %, 150 wt %, 210 wt %, 270 wt %, 330 wt %, 390 wt %, 450 wt %, 510 wt %, 570 wt %, 630 wt %, and 690 wt % to an upper limit of about 1300 wt %, 1240 wt %, 1180 wt %, 1120 wt %, 1060 wt %, 1000 wt %, 940 wt %, 880 wt %, 820 wt %, 760 wt %, 700 wt %, and 640 wt %, encompassing any value and subset therebetween.

In some embodiments, the functionalized proppant particulates comprise proppant particulates having chemically deposited thereon a functional group bound to a swellable material in its unswelled volume. The functionalized proppant particulates are then introduced into a treatment fluid comprising an aqueous base fluid, wherein the swellable material bound to the functionalized proppant particulates adopts an increased swelled volume in the aqueous base fluid, thereby self-suspending the functionalized proppant particulates in the treatment fluid. That is, each individual functionalized proppant particulate self-suspends in the treatment fluid without the need for additional gelling agents or other viscosifying agents, although such agents may be used without departing from the scope of the present disclosure. In some embodiments, the swellable material may be bound to the functional group chemically deposited onto the proppant particulates “on-the-fly” as they both are introduced into the treatment fluid to form the functionalized proppant particulates described herein. As used herein, the term “on-the-fly” refers to performing an operation during a subterranean treatment that does not require stopping normal operations. As used herein, the general term “functionalized proppant particulates” encompasses both pre-made and on-the-fly.

Thereafter, the treatment fluid comprising the functionalized proppant particulates may be introduced into a subterranean formation to perform a subterranean formation operation, such as to place the functionalized proppant particulates into an existing fracture to form a proppant pack. In other embodiments, the treatment fluid comprising the functionalized proppant particulates may be introduced into the subterranean formation at a rate and pressure sufficient to create or enhance at least one fracture therein, followed by placing the functionalized proppant particulates into the at least one fracture to form a proppant pack.

The functionalized proppant particulates described herein comprise a functional group chemically deposited onto proppant particulates. The functional group may be one or more of a particular type of functional group including, but are not limited to, an epoxy silane group, an amine silane group, an acrylyl silane group, and any combination thereof. The functional groups may be chemically deposited onto the proppant particulates in any amount ranging from a single functional group to saturation, wherein the proppant particulate is no longer able to accept a functional group for chemical deposition thereof. In some embodiments, the functional groups may be long chain and can fold on themselves and bind to the proppant particulates at more than one location and may bind more than one swellable material, as well. As used herein, the term “long chain” refers to a substance having a carbon chain in the range of a lower limit of about C6, C7, C8, C9, C10, C11, C12, C13, C14, C15, C16, C17, C18, C19, C20, C21, and C22 to an upper limit of about C40, C39, C38, C37, C36, C35, C34, C33, C32, C31, C30, C29, C28, C27, C26, C25, C24, C23, and C22.

Suitable epoxy silane functional groups may include, but are not limited to, 3-glycidoxypropyltrimethoxysilane, 3-glycidoxypropyltriethoxysilane, 3-glycidoxypropylmethyldiethoxysilane, 3-glycidoxypropylmethyldimethoxysilane, 2-(3,4-epoxycyclohyxyl)-ethyltrimethoxysilane, 2-(3,4-epoxycyclohexyl)-ethyltriethoxysilane, 5,6-epoxyhexyltriethoxysilane, and any combination thereof. Derivatives of these epoxy silane functional groups may also be used in the methods and compositions of the present disclosure without departing from the scope of the embodiments described herein.

Suitable amine silane functional groups may include, but are not limited to, N-[3-(trimethoxysilyl)propyl]ethylenediamine, N-(2)-aminoethyl)-3-aminopropyltriethoxysilane, N-(6-aminohexyl)aminomethyltriethoxysilane, N-(6-aminohexyl)aminopropyltrimethoxysilane, N-(2-aminoethyl)-11-aminoundecyltrimethoxysilane, (aminoethylaminomethyl)phenethyltrimethoxysilane, N-3-[(amino(polypropylenoxy)]aminopropyltrimethoxysilane, 3-aminopropyltriethoxysilane, 3-aminopropyltrimethoxysilane, 4-aminobutyltriethoxysilane, m-aminophenyltrimethoxysilane, p-aminophenyltrimethoxysilane, aminophenyltrimethoxysilane, 3-aminopropyltris(methoxyethoxyethoxy)silane, 11-aminoundecyltriethoxysilane, 3-(m-aminophenoxy)propyltrimethoxysilane, aminopropylsilanetriol, 3-aminopropylmethydiethoxysilane, 3-aminopropyldiisopropylethoxysilane, 3-aminopropyldimethoylthoxysilane, N-(2-aminoethyl)-3-aminopropyl-silanetriol, N-(2-aminoethyl)-3-aminopropylmethyl-dimethoxysilane, N-(2-aminoethyl)-3-aminoisobutyl-methyldimethoxysilane, (aminoethylamino)-3-isobutyl-dimethylmethoxysilane, n-butylaminopropyltrimethoxysilane, n-ethylaminoisobutyltrimethoxysilane, n-methylaminopropyltrimethoxysilane, n-phenylaminopropyltrimethoxysilane, 3-(N-allylamino)propyltrimethoxysilane, (cyclohexylaminomethyl)triethoxysilane, N-cyclohexylaminopropyltrimethoxysilane, N-ethylaminoisobutylmethyldiethoxysilane, (phenylaminomethyl)methyldimethoxysilane, N-phenylaminomethyltriethoxysilane, N-methylaminopropylmethyldimethoxysilane, diethylaminomethyltriethoxysilane, (N,N-diethyl-3-aminopropyl)trimethoxysilane, 3-(N,N-dimethylaminopropyl)trimethoxysilane, (2-N-benzylaminoethyl)-3-aminopropyl-trimethoxysilane, bis(triethoxysilylpropyl)amine, bis(trimethoxysilylpropyl)amine, bis[3-trimethoxysilyl)propyl]ethylenediamine, bis[(3-trimethoxysilyl)propyl]-ethylenediamine, bis(methyldiethoxysilylpropyl)amine, bis(methyldimethoxysilylpropyl)-N-methylamine, and any combination thereof. Derivatives of these amine silane functional groups may also be used in the methods and compositions of the present disclosure without departing from the scope of the embodiments described herein.

Suitable acrylyl silane functional groups may include, but are not limited to, an acrylamide silane, an N-alkylacrylamide silane, an acrylate silane, (3-acryloxypropyl)trimethoxysilane, methacryloxypropyltrimethoxysilane, N-(3-acryloxy-2-hydroxypropyl)3-aminopropyltriethoxysilane, 0-(methacryloxyethyl)-N-(triethoxy-silylpropyl)urethane, N-(3-methacryloxy-2-hydroxypropyl)-3-aminopropyltriethoxysilane, methacryloxymethyltriethoxysilane, methacryloxymethyltrimethoxysilane, methacryloxypropyltriethoxysilane, (3-acryloxypropyl)methyldimethoxysilane, (methacryloxymethyl)methyldiethoxysilane, (methacryloxymethyl)methyldimethoxysilane, (methacryloxypropyl)methyldiethoxysilane, (methacryloxypropyl)methyldimethoxysilane, (methacryloxypropyl)dimethylethoxysilane, (methacryloxypropyl)dimethylmethoxysilane, and any combination thereof. Derivatives of these acrylyl silane functional groups may also be used in the methods and compositions of the present disclosure without departing from the scope of the embodiments described herein.

In forming the functionalized proppant particulates disclosed herein, a swellable material is bound (e.g., by covalent bonding) to one or more functional groups chemically deposited onto the proppant particulates. In some embodiments, only a single swellable material is bound to a functional group, whereas in other embodiments, the functional groups chemically deposited onto the proppant particulates may be saturated with swellable material such that no functional group is available to bind with another swellable material.

In some embodiments, the bond between the functional group and the swellable material may be facilitated in the presence of a mild base. As used herein, the term “mild base” refers to a chemical species that donates electrons or hydroxide ions or that accepts protons, and that has a pH in the range of about 7 to about 9. Suitable mild bases may include, but are not limited to sodium borate, potassium bicarbonate, potassium acetate, sodium acetate, sodium benzoate, sodium bicarbonate, zinc hydroxide, nickel(II) hydroxide, potassium hydrogen carbonate, sodium hydrogen carbonate, lead(II) hydroxide, chromium(III) hydroxide, aliphatic amines having from C1-C6 carbon chains (e.g., methylamine and isopropyl-amine), aliphatic diamines having from C1-C6 carbon chains (e.g., ethylene diamine), and any combination thereof.

In some embodiments, the swellable material for use in forming the functionalized proppant particulates described herein is a swellable polymeric material or a salt of a swellable polymer, or any combination of the two. Suitable swellable polymeric materials may include, but are not limited to, an acrylic acid polymer, polyacrylamide, poly(meth)acrylamide, crosslinked poly(meth)acrylamide, crosslinked poly(meth)acrylate, crosslinked (meth)acrylamide/(meth)acrylate copolymers (e.g., acrylamide/sodium acrylate), a crosslinked poly(ethylene glycol), starch grafted with acrylonitrile and acrylate, crosslinked allylsulfonate, sodium polyacrylate, 2-acrylamido-2-methyl-1-propanesulfonic acid, starch-poly(sodium acrylate-co-acrylamide) hydrogel, sodium acrylate gel, 3-allyloxy-2-hydroxy-1-propanesulfonic acid, and any combination thereof. Suitable salts of swellable polymers may include, but are not limited to, salts of carboxyalkyl starch, salts of carboxymethyl starch, salts of carboxymethyl cellulose, salts of crosslinked carboxyalkyl polysaccharide, and any combination thereof.

The functionalized proppant particulates described herein may, in some embodiments, further comprise a tackifying agent chemically bound (e.g., by covalent bonding or van der Walls (electrostatic) interactions) to one or more of the functional groups chemically deposited onto the proppant particulates. That is, one or more functional groups will have chemically bound thereto a swellable material and one or more functional groups, which may be the same or different from those bound with the swellable material, and may further have bound thereto a tackifying agent. The tackifying agent may act to allow the functionalized proppant particulates to not only self-suspend, but to also adhere or attach formation fines or other loose particulates in the subterranean formation that may interfere with production operations. In some embodiments, the amount of swellable material to tackifying agent may be a ratio (swellable material:tackifying agent) between a lower limit of about 1000:1, 950:1, 900:1, 850:1, 800:1, 750:1, 700:1, 650:1, 600:1, 550:1, and 500:1 to an upper limit of about 50:1, 100:1, 150:1, 200:1, 250:1, 300:1, 350:1, 400:1, 450:1, and 500:1, encompassing any value and subset therebetween.

Suitable tackifying agents may include, but are not limited to, a polyacid (e.g., a dimer acid, a trimer acid, and the like), a dimer diamine, a trimer triamine, a hydrophobically modified polyethyleneimine, an acrylic acid polymer, an acrylic acid ester polymer, an acrylic acid derivative polymer, an acrylic acid homopolymer, an acrylic acid ester homopolymer (e.g., poly(methyl acrylate), poly(butyl acrylate), and poly(2-ethylhexyl acrylate)), an acrylic acid ester co-polymer, a methacrylic acid derivative polymer, a methacrylic acid homopolymer, a methacrylic acid ester homopolymer (e.g., poly(methyl methacrylate), poly(butyl methacrylate), and poly(2-ethylhexyl methacrylate)), an acrylamido-methyl-propane sulfonate polymer, an acrylamido-methyl-propane sulfonate derivative polymer, an acrylamido-methyl-propane sulfonate co-polymer, an acrylic acid/acrylamido-methyl-propane sulfonate co-polymer, any derivative thereof, and any combination thereof.

The proppant particulates used to form the functionalized proppant particulates and variants thereof (e.g., including tackifying agent) may be any material capable of chemically depositing the functional groups described herein. In some embodiments, the proppant particulates may be composed of a material including, but not limited to, silica, sodium silicate, meta-silicate, calcium silicate, and any combination thereof. Suitable proppant particulates may be any size and shape capable of being introduced into a subterranean formation and supporting a fracture from closing after the removal of hydraulic pressure.

Generally, where the chosen proppant particulate is substantially spherical, suitable particulates may have a size in the range of from a lower limit of about 2 mesh, 20 mesh, 40 mesh, 60 mesh, 80 mesh, 100 mesh, 120 mesh, 140 mesh, 160 mesh, 180 mesh, and 200 mesh to an upper limit of about 400 mesh, 380 mesh, 360 mesh, 340 mesh, 320 mesh, 300 mesh, 280 mesh, 260 mesh, 240 mesh, 220 mesh, and 200 mesh, U.S. Sieve Series, and encompassing any value and any subset therebetween. In some embodiments, the particulates described herein may be smaller than 400 mesh (e.g., may be as small as about 4800 mesh, an estimated sieve size equaling about 2 microns, or even smaller). In some embodiments, the particulates may have a size in the range of from about 8 to about 120 mesh, U.S. Sieve Series.

In some embodiments, it may be desirable to use substantially non-spherical proppant particulates. Suitable substantially non-spherical particulates may be cubic, polygonal, fibrous, or any other non-spherical shape. Such substantially non-spherical particulates may be, for example, cubic-shaped, rectangular-shaped, rod-shaped, ellipse-shaped, cone-shaped, pyramid-shaped, or cylinder-shaped. That is, in embodiments wherein the particulates are substantially non-spherical, the aspect ratio of the material may range such that the material is fibrous to such that it is cubic, octagonal, or any other configuration. Substantially non-spherical particulates may be generally sized such that the longest axis is from a lower limit of about 0.02 inches (“in”), 0.04 in, 0.06 in, 0.08 in, 0.1 in, 0.12 in, 0.14 in, and 0.16 in to an upper limit of about 0.3 in, 0.28 in, 0.26 in, 0.24 in, 0.22 in, 0.2 in, 0.18 in, and 0.16 in in length, and encompassing any value and any subset therebetween. In other embodiments, the longest axis is from about 0.05 inches to about 0.2 inches in length. In one embodiment, the substantially non-spherical particulates may be cylindrical, having an aspect ratio of about 1.5 to 1, a diameter of about 0.08 in, and a length of about 0.12 in. In another embodiment, the substantially non-spherical particulates may be cubic, having sides of about 0.08 inches in length.

In some embodiments, the treatment fluids comprising the functionalized proppant particulates described herein may further comprise an additive selected from the group consisting of a salt, a weighting agent, an inert solid, a fluid loss control agent, an emulsifier, a dispersion aid, a corrosion inhibitor, an emulsion thinner, an emulsion thickener, a viscosifying agent, a gelling agent, a surfactant, a particulate, a proppant, a gravel particulate, a lost circulation material, a foaming agent, a gas, a pH control additive, a breaker, a biocide, a bactericide, a crosslinker, a stabilizer, a chelating agent, a scale inhibitor, a gas hydrate inhibitor, a mutual solvent, an oxidizer, a reducer, a friction reducer, a clay stabilizing agent, and any combination thereof.

Where it is desirable to remove the swellable material from the functionalized proppant particulates, such as when self-suspension is no longer desired or when the size of the particulate is preferably smaller, or for other operational reasons, a breaker may be preferably used in the treatment fluid. Upon activation, the breaker may act to break the bond between the swellable material and the functional group without breaking the bond between the functional group and the proppant particulate. For example, when a tackifying agent is also bound to one or more functional groups chemically deposited onto the proppant particulates, the breaker may remove the swellable material while leaving intact the tackifying agent to continue to provide consolidation qualities.

Suitable breakers may include, but are not limited to acid breakers, oxidative breakers, and any combination thereof. The breakers may be delayed release breakers designed to become active after a particular time, upon reaching a certain temperature, or based on some other stimuli. Suitable oxidative breakers may include, but are not limited to, organic peroxides, alkali metal persulfates and alkali metal chlorites, bromates, chlorates, hypochlorites, permanganates, and any combination thereof. Suitable acid breakers may include, but are not limited to, acetic anhydride, fumic acid, benzoic acid, sulfonic acid, phosphoric acid, aliphatic polyesters, polylactic acid, polylactides, polyanhydrides, polyamino acids, and any combination thereof. In some embodiments, the breaker may be included in the treatment fluid in an amount in the range of a lower limit of about 1%, 1.5%, 2%, 2.5%, 3%, 3.5%, 4%, 4.5%, and 5% to an upper limit of about 10%, 9.5%, 9%, 8.5%, 8%, 7.5%, 7%, 6.5%, 6%, 5.5%, and 5% by weight of the functionalized proppant particulates.

In various embodiments, systems configured for delivering the treatment fluids comprising the functionalized proppant particulates described herein to a downhole location are described. In various embodiments, the systems can comprise a pump fluidly coupled to a tubular, the tubular containing the treatment fluids described herein. It will be appreciated that while the system described below may be used for delivering treatment fluids described herein, one or more portions of the treatment fluid may be delivered separately into the subterranean formation.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the treatment fluids to a subterranean formation at or above a fracture gradient of the subterranean formation, but it may also be used in cases where fracturing is not desired. In some embodiments, the high pressure pump may be capable of fluidly conveying particulate matter, such as the non-degradable particulates, the degradable particulates, and the proppant particulates described in some embodiments herein, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluids to the high pressure pump. In such embodiments, the low pressure pump may “step up” the pressure of the treatment fluids before reaching the high pressure pump.

In some embodiments, the systems described herein can further comprise a mixing tank that is upstream of the pump and in which the treatment fluids are formulated. In various embodiments, the pump (e.g., a low pressure pump, a high pressure pump, or a combination thereof) may convey the treatment fluids from the mixing tank or other source of the treatment fluids to the tubular. In other embodiments, however, the treatment fluids may be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluids may be drawn into the pump, elevated to an appropriate pressure, and then introduced into the tubular for delivery downhole.

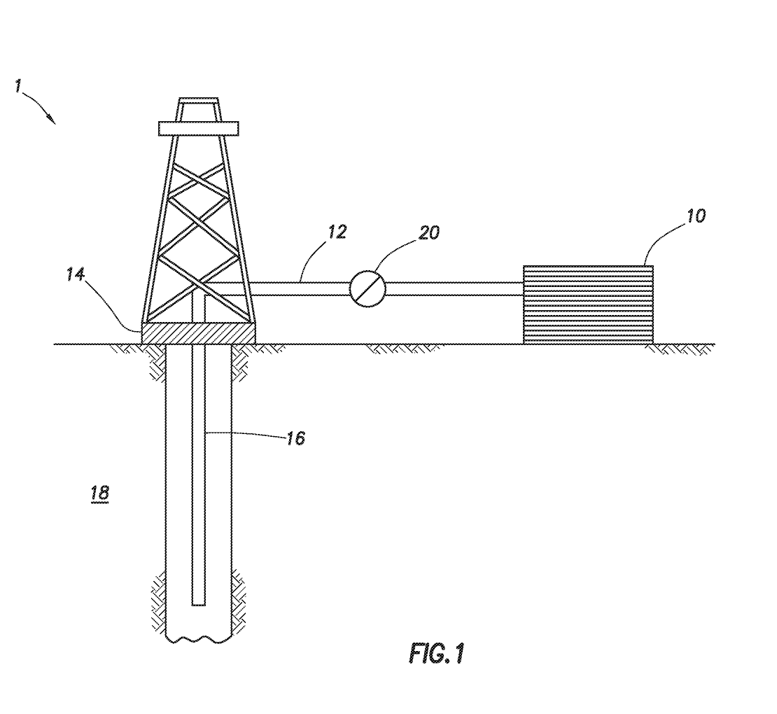

FIG. 1 shows an illustrative schematic of a system that can deliver the treatment fluids of the present disclosure to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which the treatment fluids of the embodiments herein may be formulated. The treatment fluids may be conveyed via line 12 to wellhead 14, where the treatment fluids enter tubular 16, tubular 16 extending from wellhead 14 into subterranean formation 18. Upon being ejected from tubular 16, the treatment fluids may subsequently penetrate into subterranean formation 18. Pump 20 may be configured to raise the pressure of the treatment fluids to a desired degree before introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

Embodiments disclosed herein include:

Element A:

A method comprising: providing functionalized proppant particulates, wherein the functionalized proppant particulates comprise proppant particulates having functional groups chemically deposited thereon, the functional groups selected from the group consisting of an epoxy silane group, an amine silane group, an acrylyl silane group, and any combination thereof, and a swellable material chemically bound to one or more of the functional groups, wherein the swellable material has an unswelled volume; preparing a treatment fluid comprising an aqueous base fluid and the functionalized proppant particulates, wherein the swellable material of the functionalized proppant particulates adopts an increased swelled volume in the aqueous base fluid, thereby suspending the functionalized proppant particulates therein; and introducing the treatment fluid into a subterranean.

Element B:

A method comprising: preparing a treatment fluid comprising an aqueous base fluid and providing proppant particulates having functional groups chemically deposited thereon, the functional groups selected from the group consisting of an epoxy silane group, an amine silane group, an acrylyl silane group, and any combination thereof; introducing a swellable material into the treatment fluid, wherein the swellable material chemically bonds to one or more of the functional groups, thereby forming functionalized proppant particulates, and wherein the swellable material of the functionalized proppant particulates adopts an increased swelled volume in the aqueous base fluid, thereby suspending the functionalized proppant particulates therein; and introducing the treatment fluid into a subterranean.

Element C:

Functionalized proppant particulates comprising: proppant particulates having functional groups chemically deposited thereon, the functional groups selected from the group consisting of an epoxy silane group, an amine silane group, an acrylyl silane group, and any combination thereof, and a swellable material chemically bound to one or more of the functional groups.

Embodiments A, B, and C may have one or more of the following additional elements in any combination:

Element 1: Wherein the epoxy silane group is selected from the group consisting of 3-glycidoxypropyltrimethoxysilane, 3-glycidoxypropyltriethoxysilane, 3-glycidoxypropylmethyldiethoxysilane, 3-glycidoxypropylmethyldimethoxysilane, 2-(3,4-epoxycyclohyxyl)-ethyltrimethoxysilane, 2-(3,4-epoxycyclohexyl)-ethyltriethoxysilane, 5,6-epoxyhexyltriethoxysilane, and any combination thereof.

Element 2: Wherein the amine silane group is selected from the group consisting of N-[3-(trimethoxysilyl)propyl]ethylenediamine, N-(2)-aminoethyl)-3-aminopropyltriethoxysilane, N-(6-aminohexyl)aminomethyltriethoxysilane, N-(6-aminohexyl)aminopropyltrimethoxysilane, N-(2-aminoethyl)-11-aminoundecyltrimethoxysilane, (aminoethylaminomethyl)phenethyltrimethoxysilane, N-3-[(amino(polypropylenoxy)]aminopropyltrimethoxysilane, 3-aminopropyltriethoxysilane, 3-aminopropyltrimethoxysilane, 4-aminobutyltriethoxysilane, m-aminophenyltrimethoxysilane, p-aminophenyltrimethoxysilane, aminophenyltrimethoxysilane, 3-aminopropyltris(methoxyethoxyethoxy)silane, 11-aminoundecyltriethoxysilane, 3-(m-aminophenoxy)propyltrimethoxysilane, aminopropylsilanetriol, 3-aminopropylmethydiethoxysilane, 3-aminopropyldiisopropylethoxysilane, 3-aminopropyldimethoylthoxysilane, N-(2-aminoethyl)-3-aminopropyl-silanetriol, N-(2-aminoethyl)-3-aminopropylmethyl-dimethoxysilane, N-(2-aminoethyl)-3-aminoisobutyl-methyldimethoxysilane, (aminoethylamino)-3-isobutyl-dimethylmethoxysilane, n-butylaminopropyltrimethoxysilane, n-ethylaminoisobutyltrimethoxysilane, n-methylaminopropyltrimethoxysilane, n-phenylaminopropyltrimethoxysilane, 3-(N-allylamino)propyltrimethoxysilane, (cyclohexylaminomethyl)triethoxysilane, N-cyclohexylaminopropyltrimethoxysilane, N-ethylaminoisobutylmethyldiethoxysilane, (phenylaminomethyl)methyldimethoxysilane, N-phenylaminomethyltriethoxysilane, N-methylaminopropylmethyldimethoxysilane, diethylaminomethyltriethoxysilane, (N,N-diethyl-3-aminopropyl)trimethoxysilane, 3-(N,N-dimethylaminopropyl)trimethoxysilane, (2-N-benzylaminoethyl)-3-aminopropyl-trimethoxysilane, bis(triethoxysilylpropyl)amine, bis(trimethoxysilylpropyl)amine, bis[3-trimethoxysilyl)propyl]ethylenediamine, bis[(3-trimethoxysilyl)propyl]-ethylenediamine, bis(methyldiethoxysilylpropyl)amine, bis(methyldimethoxysilylpropyl)-N-methylamine, and any combination thereof.

Element 3: Wherein the acrylyl silane group is selected from the group consisting of an acrylamide silane, an N-alkylacrylamide silane, an acrylate silane, (3-acryloxypropyl)trimethoxysilane, methacryloxypropyltrimethoxysilane, N-(3-acryloxy-2-hydroxypropyl)3-aminopropyltriethoxysilane, O-(methacryloxyethyl)-N-(triethoxy-silylpropyl)urethane, N-(3-methacryloxy-2-hydroxypropyl)-3-aminopropyltriethoxysilane, methacryloxymethyltriethoxysilane, methacryloxymethyltrimethoxysilane, methacryloxypropyltriethoxysilane, (3-acryloxypropyl)methyldimethoxysilane, (methacryloxymethyl)methyldiethoxysilane, (methacryloxymethyl)methyldimethoxysilane, (methacryloxypropyl)methyldiethoxysilane, (methacryloxypropyl)methyldimethoxysilane, (methacryloxypropyl)dimethylethoxysilane, (methacryloxypropyl)dimethylmethoxysilane, and any combination thereof.

Element 4: Wherein the swellable material is a swellable polymeric material selected from the group consisting of an acrylic acid polymer, polyacrylamide, poly(meth)acrylamide, crosslinked poly(meth)acrylamide, crosslinked poly(meth)acrylate, crosslinked (meth)acrylamide/(meth)acrylate copolymers (e.g., acrylamide/sodium acrylate), a crosslinked poly(ethylene glycol), starch grafted with acrylonitrile and acrylate, crosslinked allylsulfonate, sodium polyacrylate, 2-acrylamido-2-methyl-1-propanesulfonic acid, starch-poly(sodium acrylate-co-acrylamide) hydrogel, sodium acrylate gel, 3-allyloxy-2-hydroxy-1-propanesulfonic acid, and any combination thereof.

Element 5: Wherein the swellable material is a salt of a swellable polymer selected from the group consisting of salts of carboxyalkyl starch, salts of carboxymethyl starch, salts of carboxymethyl cellulose, salts of crosslinked carboxyalkyl polysaccharide, and any combination thereof.

Element 6: Wherein the swelled volume of the swellable material is between about 30 to about 50 times greater than the unswelled volume of the swellable material.

Element 7: Wherein the swellable material is chemically bound to the functional group in the presence of a mild base catalyst.

Element 8: Wherein the functionalized proppant particulate further comprises a tackifying agent chemically bound to one or more of the functional groups.

Element 9: Further comprising a wellhead with a tubular extending therefrom and into the subterranean formation and a pump fluidly coupled to the tubular, wherein the at least one of the treatment fluid or the functionalized proppant particulates are introduced into a subterranean formation through the tubular.

By way of non-limiting example, exemplary combinations applicable to A, B, and C include: 1 and 2; 4, 5, and 9; 3, 6, and 8; 2 and 3; 4 and 6; 5, 6, and 7; 1 through 9; 3 and 9; 6, 7, and 8.

To facilitate a better understanding of the embodiments of the present disclosure, the following examples of preferred or representative embodiments are given. In no way should the following examples be read to limit, or to define, the scope of the disclosure.

Therefore, the embodiments disclosed herein are well adapted to attain the ends and advantages mentioned as well as those that are inherent therein. The particular embodiments disclosed above are illustrative only, as they may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
providing functionalized proppant particulates,
wherein the functionalized proppant particulates comprise proppant particulates having functional groups chemically deposited thereon, the functional groups selected from the group consisting of an epoxy silane group, an amine silane group, an acrylyl silane group, and any combination thereof, and a swellable material chemically bound to one or more of the functional groups,
wherein the swellable material has an unswelled volume;
preparing a treatment fluid comprising an aqueous base fluid and the functionalized proppant particulates,
wherein the swellable material of the functionalized proppant particulates adopts an increased swelled volume in the aqueous base fluid, thereby suspending the functionalized proppant particulates therein; and
introducing the treatment fluid into a subterranean.

2. The method of claim 1, wherein the epoxy silane group is selected from the group consisting of 3-glycidoxypropyltrimethoxysilane, 3-glycidoxypropyltriethoxysilane, 3-glycidoxypropylmethyldiethoxysilane, 3-glycidoxypropylmethyldimethoxysilane, 2-(3,4-epoxycyclohyxyl)-ethyltrimethoxysilane, 2-(3,4-epoxycyclohexyl)-ethyltriethoxysilane, 5,6-epoxyhexyltriethoxysilane, and any combination thereof.

3. The method of claim 1, wherein the amine silane group is selected from the group consisting of N-[3-(trimethoxysilyl)propyl]ethylenediamine, N-(2)-aminoethyl)-3-aminopropyltriethoxysilane, N-(6-aminohexyl)aminomethyltriethoxysilane, N-(6-aminohexyl)aminopropyltrimethoxysilane, N-(2-aminoethyl)-11-aminoundecyltrimethoxysilane, (aminoethylaminomethyl)phenethyltrimethoxysilane, N-3-[(amino(polypropylenoxy)]aminopropyltrimethoxysilane, 3-aminopropyltriethoxysilane, 3-aminopropyltrimethoxysilane, 4-aminobutyltriethoxysilane, m-aminophenyltrimethoxysilane, p-aminophenyltrimethoxysilane, aminophenyltrimethoxysilane, 3-aminopropyltris(methoxyethoxyethoxy)silane, 11-aminoundecyltriethoxysilane, 3-(m-aminophenoxy)propyltrimethoxysilane, aminopropylsilanetriol, 3-aminopropylmethydiethoxysilane, 3-aminopropyldiisopropylethoxysilane, 3-aminopropyldimethoylthoxysilane, N-(2-aminoethyl)-3-aminopropyl-silanetriol, N-(2-aminoethyl)-3-aminopropylmethyl-dimethoxysilane, N-(2-aminoethyl)-3-aminoisobutyl-methyldimethoxysilane, (aminoethylamino)-3-isobutyl-dimethylmethoxysilane, n-butylaminopropyltrimethoxysilane, n-ethylaminoisobutyltrimethoxysilane, n-methylaminopropyltrimethoxysilane, n-phenylaminopropyltrimethoxysilane, 3-(N-allylamino)propyltrimethoxysilane, (cyclohexylaminomethyl)triethoxysilane, N-cyclohexylaminopropyltrimethoxysilane, N-ethylaminoisobutylmethyldiethoxysilane, (phenylaminomethyl)methyldimethoxysilane, N-phenylaminomethyltriethoxysilane, N-methylaminopropylmethyldimethoxysilane, diethylaminomethyltriethoxysilane, (N,N-diethyl-3-aminopropyl)trimethoxysilane, 3-(N,N-dimethylaminopropyl)trimethoxysilane, (2-N-benzylaminoethyl)-3-aminopropyl-trimethoxysilane, bis(triethoxysilylpropyl)amine, bis(trimethoxysilylpropyl)amine, bis[3-trimethoxysilyl)propyl]ethylenediamine, bis[(3-trimethoxysilyl)propyl]-ethylenediamine, bis(methyldiethoxysilylpropyl)amine, bis(methyldimethoxysilylpropyl)-N-methylamine, and any combination thereof.

4. The method of claim 1, wherein the acrylyl silane group is selected from the group consisting of an acrylamide silane, an N-alkylacrylamide silane, an acrylate silane, (3-acryloxypropyl)trimethoxysilane, methacryloxypropyltrimethoxysilane, N-(3-acryloxy-2-hydroxypropyl)3-aminopropyltriethoxysilane, O-(methacryloxyethyl)-N-(triethoxy-silylpropyl)urethane, N-(3-methacryloxy-2-hydroxypropyl)-3-aminopropyltriethoxysilane, methacryloxymethyltriethoxysilane, methacryloxymethyltrimethoxysilane, methacryloxypropyltriethoxysilane, (3-acryloxypropyl)methyldimethoxysilane, (methacryloxymethyl)methyldiethoxysilane, (methacryloxymethyl)methyldimethoxysilane, (methacryloxypropyl)methyldiethoxysilane, (methacryloxypropyl)methyldimethoxysilane, (methacryloxypropyl)dimethylethoxysilane, (methacryloxypropyl)dimethylmethoxysilane, and any combination thereof.

5. The method of claim 1, wherein the swellable material is a swellable polymeric material selected from the group consisting of an acrylic acid polymer, polyacrylamide, poly(meth)acrylamide, crosslinked poly(meth)acrylamide, crosslinked poly(meth)acrylate, crosslinked (meth)acrylamide/(meth)acrylate copolymers (e.g., acrylamide/sodium acrylate), a crosslinked poly(ethylene glycol), starch grafted with acrylonitrile and acrylate, crosslinked allylsulfonate, sodium polyacrylate, 2-acrylamido-2-methyl-1-propanesulfonic acid, starch-poly(sodium acrylate-co-acrylamide) hydrogel, sodium acrylate gel, 3-allyloxy-2-hydroxy-1-propanesulfonic acid, and any combination thereof.

6. The method of claim 1, wherein the swellable material is a salt of a swellable polymer selected from the group consisting of salts of carboxyalkyl starch, salts of carboxymethyl starch, salts of carboxymethyl cellulose, salts of crosslinked carboxyalkyl polysaccharide, and any combination thereof.

7. The method of claim 1, wherein the swelled volume of the swellable material is between about 30 to about 50 times greater than the unswelled volume of the swellable material.

8. The method of claim 1, wherein the swellable material is chemically bound to the functional group in the presence of a mild base catalyst.

9. The method of claim 1, wherein the functionalized proppant particulate further comprises a tackifying agent chemically bound to one or more of the functional groups.

10. The method of claim 1, further comprising a wellhead with a tubular extending therefrom and into the subterranean formation and a pump fluidly coupled to the tubular,
wherein the step of introducing the treatment fluid into the subterranean formation comprises introducing the treatment fluid through the tubular.

11. A method comprising:
preparing a treatment fluid comprising an aqueous base fluid and providing proppant particulates having functional groups chemically deposited thereon, the functional groups selected from the group consisting of an epoxy silane group, an amine silane group, an acrylyl silane group, and any combination thereof;
introducing a swellable material into the treatment fluid,
wherein the swellable material chemically bonds to one or more of the functional groups, thereby forming functionalized proppant particulates, and
wherein the swellable material of the functionalized proppant particulates adopts an increased swelled volume in the aqueous base fluid, thereby suspending the functionalized proppant particulates therein; and
introducing the treatment fluid into a subterranean.

12. The method of claim 11, wherein the epoxy silane group is selected from the group consisting of 3-glycidoxypropyltrimethoxysilane, 3-glycidoxypropyltriethoxysilane, 3-glycidoxypropylmethyldiethoxysilane, 3-glycidoxypropylmethyldimethoxysilane, 2-(3,4-epoxycyclohyxyl)-ethyltrimethoxysilane, 2-(3,4-epoxycyclohexyl)-ethyltriethoxysilane, 5,6-epoxyhexyltriethoxysilane, and any combination thereof.

13. The method of claim 11, wherein the amine silane group is selected from the group consisting of N-[3-(trimethoxysilyl)propyl]ethylenediamine, N-(2)-aminoethyl)-3-aminopropyltriethoxysilane, N-(6-aminohexyl)aminomethyltriethoxysilane, N-(6-aminohexyl)aminopropyltrimethoxysilane, N-(2-aminoethyl)-11-aminoundecyltrimethoxysilane, (aminoethylaminomethyl)phenethyltrimethoxysilane, N-3-[(amino(polypropylenoxy)]aminopropyltrimethoxysilane, 3-aminopropyltriethoxysilane, 3-aminopropyltrimethoxysilane, 4-aminobutyltriethoxysilane, m-aminophenyltrimethoxysilane, p-aminophenyltrimethoxysilane, aminophenyltrimethoxysilane, 3-aminopropyltris(methoxyethoxyethoxy)silane, 11-aminoundecyltriethoxysilane, 3-(m-aminophenoxy)propyltrimethoxysilane, aminopropylsilanetriol, 3-aminopropylmethydiethoxysilane, 3-aminopropyldiisopropylethoxysilane, 3-aminopropyldimethoylthoxysilane, N-(2-aminoethyl)-3-aminopropyl-silanetriol, N-(2-aminoethyl)-3-aminopropylmethyl-dimethoxysilane, N-(2-aminoethyl)-3-aminoisobutyl-methyldimethoxysilane, (aminoethylamino)-3-isobutyl-dimethylmethoxysilane, n-butylaminopropyltrimethoxysilane, n-ethylaminoisobutyltrimethoxysilane, n-methylaminopropyltrimethoxysilane, n-phenylaminopropyltrimethoxysilane, 3-(N-allylamino)propyltrimethoxysilane, (cyclohexylaminomethyl)triethoxysilane, N-cyclohexylaminopropyltrimethoxysilane, N-ethylaminoisobutylmethyldiethoxysilane, (phenylaminomethyl)methyldimethoxysilane, N-phenylaminomethyltriethoxysilane, N-methylaminopropylmethyldimethoxysilane, diethylaminomethyltriethoxysilane, (N,N-diethyl-3-aminopropyl)trimethoxysilane, 3-(N,N-dimethylaminopropyl)trimethoxysilane, (2-N-benzylaminoethyl)-3-aminopropyl-trimethoxysilane, bis(triethoxysilylpropyl)amine, bis(trimethoxysilylpropyl)amine, bis[3-trimethoxysilyl)propyl]ethylenediamine, bis[(3-trimethoxysilyl)propyl]-ethylenediamine, bis(methyldiethoxysilylpropyl)amine, bis(methyldimethoxysilylpropyl)-N-methylamine, and any combination thereof.

14. The method of claim 11, wherein the acrylyl silane group is selected from the group consisting of an acrylamide silane, an N-alkylacrylamide silane, an acrylate silane, (3-acryloxypropyl)trimethoxysilane, methacryloxypropyltrimethoxysilane, N-(3-acryloxy-2-hydroxypropyl)3-aminopropyltriethoxysilane, O-(methacryloxyethyl)-N-(triethoxy-silylpropyl)urethane, N-(3-methacryloxy-2-hydroxypropyl)-3-aminopropyltriethoxysilane, methacryloxymethyltriethoxysilane, methacryloxymethyltrimethoxysilane, methacryloxypropyltriethoxysilane, (3-acryloxypropyl)methyldimethoxysilane, (methacryloxymethyl)methyldiethoxysilane, (methacryloxymethyl)methyldimethoxysilane, (methacryloxypropyl)methyldiethoxysilane, (methacryloxypropyl)methyldimethoxysilane, (methacryloxypropyl)dimethylethoxysilane, (methacryloxypropyl)dimethylmethoxysilane, and any combination thereof.

15. The method of claim 11, wherein the swellable material is a swellable polymeric material selected from the group consisting of an acrylic acid polymer, polyacrylamide, poly(meth)acrylamide, crosslinked poly(meth)acrylamide, crosslinked poly(meth)acrylate, crosslinked (meth)acrylamide/(meth)acrylate copolymers (e.g., acrylamide/sodium acrylate), a crosslinked poly(ethylene glycol), starch grafted with acrylonitrile and acrylate, crosslinked allylsulfonate, sodium polyacrylate, 2-acrylamido-2-methyl-1-propanesulfonic acid, starch-poly(sodium acrylate-co-acrylamide) hydrogel, sodium acrylate gel, 3-allyloxy-2-hydroxy-1-propanesulfonic acid, and any combination thereof.

16. The method of claim 11, wherein the swellable material is a salt of a swellable polymer selected from the group consisting of salts of carboxyalkyl starch, salts of carboxymethyl starch, salts of carboxymethyl cellulose, salts of crosslinked carboxyalkyl polysaccharide, and any combination thereof.

17. The method of claim 11, wherein the swellable material is chemically bound to the functional group in the presence of a mild base catalyst.

18. The method of claim 11, wherein the functionalized proppant particulate further comprises a tackifying agent chemically bound to one or more of the functional groups.

19. The method of claim 11, further comprising a wellhead with a tubular extending therefrom and into the subterranean formation and a pump fluidly coupled to the tubular,
wherein the step of introducing the treatment fluid into the subterranean formation comprises introducing the treatment fluid through the tubular.

20. Functionalized proppant particulates comprising:
proppant particulates having functional groups chemically deposited thereon, the functional groups selected from the group consisting of an epoxy silane group, an amine silane group, an acrylyl silane group, and any combination thereof, and a swellable material chemically bound to one or more of the functional groups.
